(19) United States
(12) Patent Application Publication
(10) Pub. No.: US 2011/0020684 A1
(43) Pub. Date: Jan. 27, 2011

(54) BATTERY COVER LATCHING ASSEMBLY

(75) Inventors: HUA-XIANG LIANG, Shenzhen City (CN); JUN WANG, Shenzhen City (CN); HSIAO-HUA TU, Taipei (TW)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/610,509

(22) Filed: Nov. 2, 2009

(30) Foreign Application Priority Data
Jul. 23, 2009 (CN) 200910304758.3

(51) Int. Cl. H01M 2/10

(52) U.S. Cl. 429/100

(57) ABSTRACT

A battery cover latching assembly comprises a body member, a battery cover, and two elastic members. One end of the battery cover is rotatably mounted to the body member, the other end of the battery cover is releasably latched to the body member. The two elastic members are sandwiched between the battery cover and the body member, used to prop up the battery cover.

### BACKGROUND

1. Technical Field

The present disclosure relates to battery covers and, particularly, to a battery cover latching assembly used in a portable electronic device.

2. Description of Related Art

Batteries are used to provide power to portable electronic devices, e.g., mobile phones. Battery cover latching assemblies are usually provided to secure the battery within portable electronic devices.

A typical battery cover latching assembly for an electronic device usually includes a battery cover and latching means, e.g., a locking pin latching into a locking hole. The battery cover can be detachably mounted to a housing of portable electronic devices using the latching means.

However, to replace batteries, it is required to first detach the battery cover from the housing, then insert a new battery into the housing and finally lock the battery cover to the housing again. Thus, it is inconvenient for users, and the battery cover may subject to risk of being lost or misplaced.

Therefore, there is room for improvement within the art.

### BRIEF DESCRIPTION OF THE DRAWINGS

Many aspects of the battery cover latching assembly can be better understood with reference to the following drawings. These drawings are not necessarily drawn to scale, the emphasis instead being placed upon clearly illustrating the principles of the present battery cover latching assembly. Moreover, in the drawings like reference numerals designate corresponding sections throughout the several views.

FIG. 1 is an exploded, isometric view of a battery cover latching assembly, in accordance with an exemplary embodiment.

FIG. 2 is similar to FIG. 1, but viewed from another aspect.

FIG. 3 is an enlarged, isometric view of the latching mechanism shown in FIG. 1.

FIG. 4 is a partially assembled view of the battery cover latching assembly shown in FIG. 1.

FIG. 5 is an assembled view of the battery cover latching assembly shown in FIG. 1 in a closed position.

FIG. 6 is an assembled view of the battery cover latching assembly shown in FIG. 1 in an intermediate position.

FIG. 7 is an assembled view of the battery cover latching assembly in an opened position shown in FIG. 5.

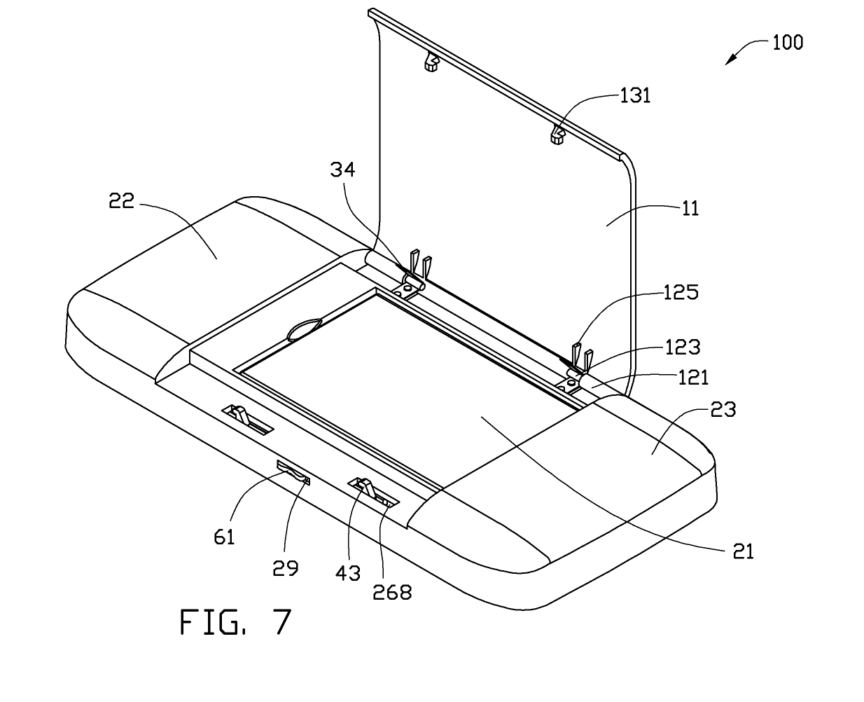

### DETAILED DESCRIPTION

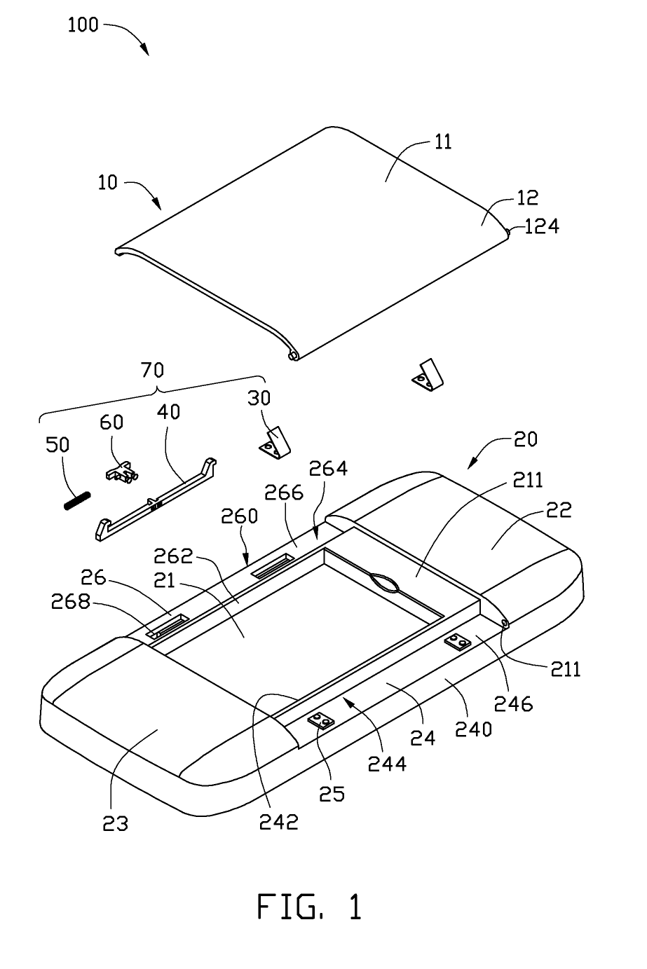

FIGS. 1 through 3 show an exemplary battery cover latching assembly 100 used in portable electronic devices, such as mobile phone terminals, digital cameras, and others. The battery cover latching assembly 100 includes a battery cover 10, a body member 20 and a latching mechanism 70. The battery cover 10 is rotatably mounted to the body member 20, and disengageably latched to the body member 20 by the latching mechanism 70. The latching mechanism 70 is slidably mounted to the body member 20. The latching mechanism 70 includes a biasing mechanism 30, a latch bar 40, a spring 50, and a button member 60.

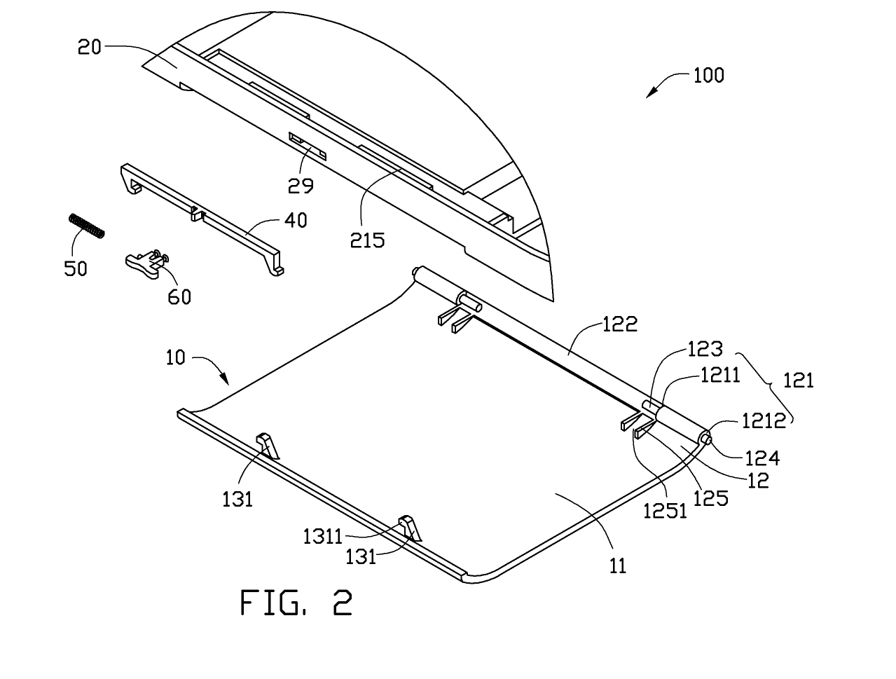

Referring to FIGS. 1 and 2, the battery cover 10 includes a main section 11, a pivoting section 12, and a latch section 13. The pivoting section 12 and the latch section 13 are located at two opposite sides of the main section 11. The pivoting section 12 is arced and pivoted to the body member 20. The latch section 13 is arced and for latching with the body member 20. Two mounting blocks 121 spacingly protrude from the pivoting section 12, spaced from the main section 11. The two mounting blocks 121 are aligned with each other, and each mounting block 121 includes a first end 1211 facing inwardly and a second end 1212 facing outwardly. The pivoting section 12 defines a space 122 between the two first ends 1211. In this embodiment, the space 122 is arced and configured for receiving the biasing mechanism 30. A pin 123 protrudes from each first end 1211, used to mount the biasing mechanism 30. A projection 124 protrudes from the second end 1212, used to be pivotably mounted to the body member 20. Two limiting blocks 125 parallelly protrude from the pivoting section 12 adjacent to each pin 123. The two limiting blocks 125 define a receiving cutout 1251 therebetween, facing the pin 123, used to receive the latching mechanism 70. Two latches 131 spacingly protrude from the latch section 13. Each latch 131 includes a latch portion 1311 parallel protruding along the pin 123.

Referring to FIGS. 1 through 3, the body member 20 is a generally rectangular housing of a portable electronic device. The body member 20 defines a battery receiving space 21. The battery receiving space 21 is surrounded by a top portion 22, a bottom portion 23, a first longitudinal side portion 24, and a second longitudinal side portion 26.

The first longitudinal side portion 24 includes an outer surface 240 and an inner surface 242. The first longitudinal side portion 24 defines a first mounting groove 244 through the outer surface 240, forming a first bottom wall 246. The top portion 22 and the bottom portion 23 respectively define a pivoting hole 211 communicating with the first mounting groove 244, corresponding to the projections 124. The two pivoting holes 211 are co-axial, configured for rotatably receiving the two projections 124. Two mounting portions 25 spacingly protrude from the first bottom wall 246, used to secure the biasing mechanism 30.

The second longitudinal side portion 26 includes an outer surface 260 and an inner surface 262. The second longitudinal side portion 26 defines a second mounting groove 264 through the outer surface 260, forming a second bottom wall 266. The second longitudinal side portion 26 spacingly defines two cavities 268 in the second bottom wall 266. Each cavity 268 extends longitudinally. The pair of protrusions 27, protrude from an inside of the second bottom wall 266. The pair of protrusions 27 extends along two edges of the corresponding cavity 268, thus defining a channel 28 communicating with the cavity 268, and extending along the cavity 268. The channel 28 is used to receive the latch bar 40, such that the latch bar 40 slides along the channel 28. A gap 29 is defined through the outer surface 260 adjacent to the second mounting groove 264, corresponding to the channel 28. The button member 60 is slidably received in the gap 29, combined with the latch bar 40. An “L”-shaped limiting board 291 is arranged in the second longitudinal side portion 26. One end of the limiting board 291 is connected to an inside of the outer surface 260, the other end of the limiting board 291 is connected to an inside of the second bottom wall 266, thus defining a slot 292. The slot 292 is adjacent to the gap 29, and extends along the channel 28. In this embodiment, part of one protrusion is received in the slot 292, used to resist one end of the spring 50.

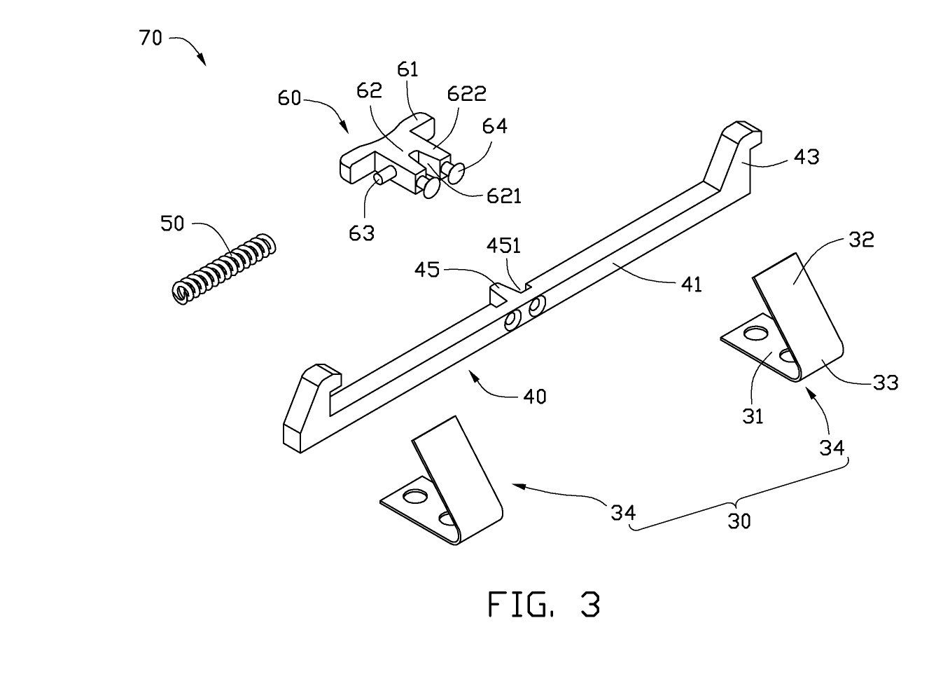

Referring to FIG. 3, the biasing mechanism 30 includes two elastic members. Each elastic member 34 is a “V”-shaped sheet, and includes a securing end 31, a resisting end 32, and a connecting portion 33. The connecting portion 33 is arcuate, with one end connected to the securing end 31, and the other end connected to the resisting end 32. The securing end 31 is fastened to the mounting portion 25 in a typical means, e.g., screwing. The resisting end 32 is received in one receiving cutout 1251, used to resist the battery cover 11. The connecting portion 33 surrounds the pin 123, and received in the space 122. When the resisting end 32 is biased towards the securing end 31, the elastic member 34 generates a resisting force outwardly.

The latch bar 40 includes a main portion 41, and two clamps 43. The main portion 41 is a long, narrow pole. The two clamps 43 protrude from opposite ends of the main portion 41, facing in a same direction. A linking portion 45 protrudes from near a center of the main portion 41, for connecting with the button member 60. The main portion 41 defines two notches 451 adjacent to two opposite sides of the linking portion 45.

The coiled spring 50 is a compressing spring, and configured for being received in the slot 292, with one end resisting one protrusion 27, the other end resisting the button member 60. The coiled spring 50 provides a restoring force to recover the button member 60.

The button member 60 is substantially T-shaped and includes an operating portion 61 and a pressing portion 62. The pressing portion 62 protrudes from a middle portion of the operating portion 61. A pole 63 protrudes from the pressing portion 62. The pole 63 is generally parallel with the operating portion 61. The coiled spring 50 is coiled about the pole 63. The pressing portion 62 defines an aperture 621 facing away from the operating portion 61, thus forming two legs 622. The aperture 621 receives the linking portion 45, with each leg 622 embedded into one corresponding notch 451, and further fastened, e.g., screwed to the main portion 41 of the latch bar 40 by screws 64.

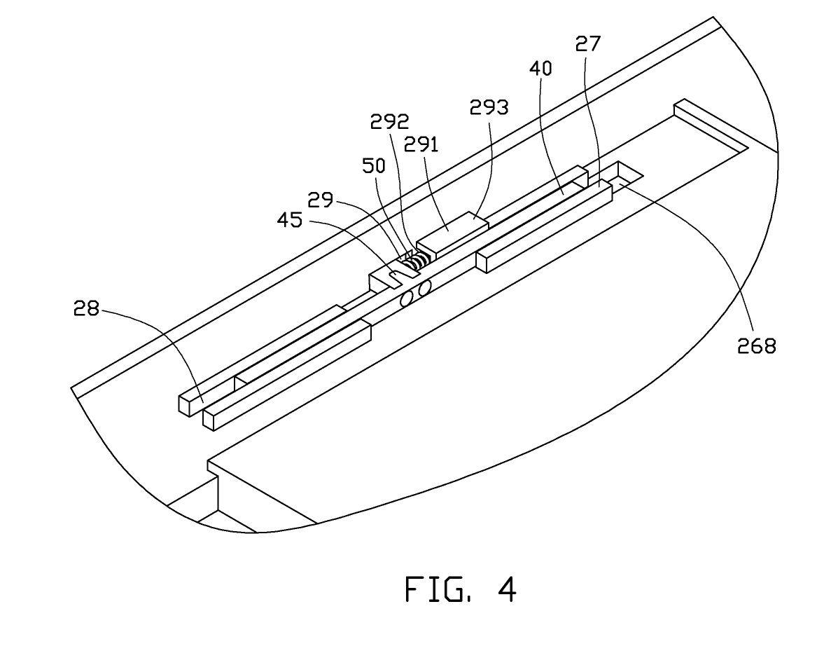

Referring to FIGS. 1 through 4, in assembly, the securing ends 31 of the two elastic members 34 are secured to the mounting portions 25. The resisting ends 32 penetrate through between the pins 123 and the pivoting section 12 until the connecting portions 33 surround the pins 123, and received in the space 122. The projections 124 are respectively and rotatably received in the pivoting holes 221, thus the battery cover 10 is rotatably mounted to the body member 20. The latch bar 40 is slidably received in the channel 28, with the linking portion 45 facing the gap 29. The coiled spring 50 is inserted into the slot 292. The button member 60 is inserted into the gap 29, until the aperture 621 receives the linking portion 45, and the two legs 622 embedded into the notch 451. The pressing portion 62 is screwed to the latch bar 40. The coiled spring 50 is compressed to make one end of the coiled spring 50 coil about the pole 63.

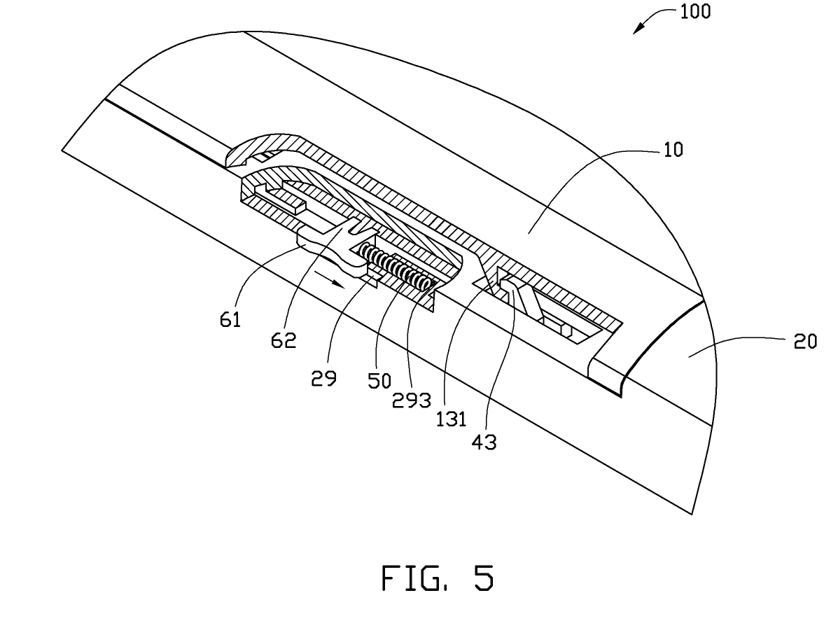

Referring to FIG. 5, to latch the battery cover 10 to the body member 20, an external force is exerted on the battery cover 10. The battery cover 10 is rotated about the projections 124 towards the body member 20 until the latches 131 resists the clamps 43. The battery cover 10 is further pushed towards the body member 20. During this stage, the latches 131 push the clamps 43 to slide against the coiled spring 50, until the latches 131 go over the clamps 43. At this time, the battery cover 10 completely covers the battery receiving space 21, and the latches 131 clamp with the clamps 43 by the coiled spring 50.

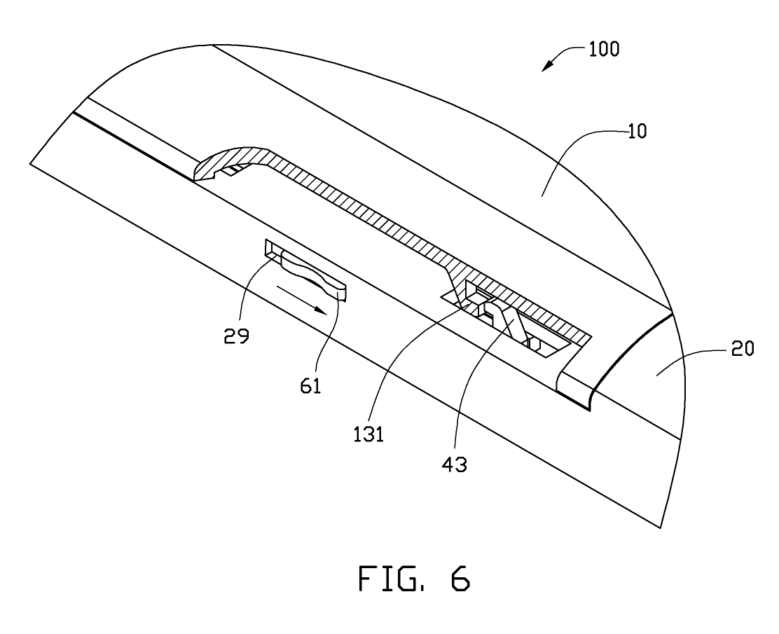

Referring to FIG. 6, to release the battery cover 10 from the body member 20, another external force is exerted on the button member 60 to slide along the aperture 29 until the clamps 43 detach from the latch portions 1311. At this time, the elastic members 34 will prop up the battery cover 10 around the projections 124.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of sections within the principles of the disclosure to the full extent indicated by the broad general meaning of the terms, in which the appended claims are expressed.

What is claimed is:

1. A battery cover latching assembly comprising:
a body member;
a battery cover, one side of the battery cover rotatably mounted to the body member, the other side of the battery cover being releasably latched to the body member;
a biasing mechanism mounted on the body member and sandwiched between the battery cover and the body member, the biasing mechanism configured for popping open the battery cover when the battery cover is released from being latched to the body member.

2. The battery cover latching assembly as claimed in claim 1, wherein the battery cover includes a main section, a pivoting section, and a latch section, the pivoting section and the latch section are located at two opposite sides of the main section, the pivoting section is pivoted to the body member, the latch section is latched to the body member.

3. The battery cover latching assembly as claimed in claim 2, wherein two mounting blocks spacingly protrude from the pivoting section, and each mounting block includes a first end facing inwardly and a second end facing outwardly, a projection protrudes from the second end, used to be pivotably mounted to the body member.

4. The battery cover latching assembly as claimed in claim 3, wherein the pivoting section defines a space between the two first ends, configured for receiving the elastic members.

5. The battery cover latching assembly as claimed in claim 3, wherein a pin protrudes from each first end, used to mount the elastic members.

6. The battery cover latching assembly as claimed in claim 5, wherein two limiting blocks parallelly protrude from the pivoting section adjacent to each pin, the two limiting blocks define a receiving cutout, facing the pin, used to receive the elastic members.

7. The battery cover latching assembly as claimed in claim 2, further comprising a latch bar slidably mounted in the body member, wherein two latches spacingly protrude from the latch section, the latch bar includes two clamps, the two clamps latch with the latches.

8. The battery cover latching assembly as claimed in claim 7, further comprising a coiled spring, the coiled spring provides a restoring force to recover the latch bar.

9. The battery cover latching assembly as claimed in claim 8, further comprising a button member, wherein the button member is slidably mounted to the body member, one end of the button member is fastened to the latch bar, the other end of the button member exposes out of the body member, the spring is sandwiched between the button member and the body member.

10. The battery cover latching assembly as claimed in claim 9, wherein a pole protrudes from the button member, the coiled spring coils about the pole.

11. The battery cover latching assembly as claimed in claim 1, wherein the biasing mechanism includes two elastic members, each elastic member includes a “V”-shaped sheet.

12. A battery cover latching assembly comprising:
a body member;
a battery cover, one side of the battery cover rotatably mounted to the body member, the other side of the battery cover being releasably latched to the body member;
a biasing mechanism comprising a securing end, a resisting end, and a connecting portion, one end of the connecting portion being connected to the securing end, and the other end being connected to the resisting end, the securing end being fastened to the body member, the resisting end being configured for resisting the battery cover.

13. The battery cover latching assembly as claimed in claim 12, wherein the battery cover includes a main section, a pivoting section, and a latch section, the pivoting section and the latch section are located at two opposite sides of the main section, the pivoting section is pivoted to the body member, and the latch section is latched to the body member.

14. The battery cover latching assembly as claimed in claim 13, wherein two mounting blocks spacingly protrude from the pivoting section, and each mounting block includes a first end facing inwardly and a second end facing outwardly, a projection protrudes from the second end, used to be pivotably mounted to the body member.

15. The battery cover latching assembly as claimed in claim 14, wherein the pivoting section defines a space between the two first ends, configured for receiving the connecting portion.

16. The battery cover latching assembly as claimed in claim 14, wherein a pin protrudes from each first end, the connecting portion surrounds the pin.

17. The battery cover latching assembly as claimed in claim 16, wherein two limiting blocks parallelly protrude from the pivoting section adjacent to each pin, the two limiting blocks define a receiving cutout, facing the pin, used to receive the resisting portion.

18. The battery cover latching assembly as claimed in claim 12, wherein the biasing mechanism includes two elastic members, each elastic member includes a “V”-shaped sheet.
